(19) United States
(12) Patent Application Publication
(10) Pub. No.: US 2010/0079525 A1
(43) Pub. Date: Apr. 1, 2010

(54) REFERENCE MARK FORMING DEVICE AND RECORDING APPARATUS PROVIDED WITH THE REFERENCE MARK FORMING DEVICE

(75) Inventor: Toshiyuki SUZUKI, Shiojiri-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/568,810

(22) Filed: Sep. 29, 2009

(30) Foreign Application Priority Data
Sep. 30, 2008 (JP) 2008-254269
May 29, 2009 (JP) 2009-130646

(51) Int. Cl. B41J 29/38

(52) U.S. Cl. 347/14

(57) ABSTRACT

A reference mark forming device configured to form reference marks on a recorded material to be transported in a predetermined transporting direction by a transporting device at a predetermined regular pitch in the transporting direction including: a reference-mark-specific head configured to form the reference marks on the recorded material transported by the transporting device; a mark detection sensor configured to detect the reference marks formed on the recorded material by the reference-mark-specific head on the downstream side of the reference-mark-specific head in terms of the transporting direction; and a head drive unit configured to drive the reference-mark-specific head on the basis of an output signal from the mark detection sensor, in which the reference-mark-specific head and the mark detection sensor are arranged so that the relative positional relation is maintained constant.

### BACKGROUND

1. Technical Field

The present invention relates to a reference mark forming device configured to form reference marks with a predetermined regular pitch in the transporting direction on a recorded material transported by a transporting device in a recording apparatus having the transporting device configured to transport the recorded material in the predetermined transporting direction and a recording head configured to form dots on a recording surface of the recorded material transported by the transporting device.

2. Related Art

As an example of a recording apparatus having a transporting device configured to transport a recorded material in a predetermined transporting direction and a recording head configured to form dots on a recording surface of the recorded material transported by the transporting apparatus, a line-head type ink jet recorder is publicly known. In the recording apparatus in this configuration, extremely high recording accuracy is realized by providing a device to cause the timing to form the dots by the recording head to be synchronized with the transported position of the recorded material.

As an example of the recording apparatus having such a device in the related art, a recording apparatus provided with an encoder device having a linear scale attached to a transport belt configured to transport the recorded material and a sensor configured to detect the linear scale is publicly known. The related art as described above is configured to detect the linear scale attached to the transport belt by the sensor and drive the recording head synchronously with timing signals outputted from the sensor. In other words, the related art is configured to synchronize the dot formation timing by the recording head with the transported position of the recorded material (see JP-A-11-245383).

Also, as another example of the related art, a recording apparatus including a device configured to record a mark regularly on a recorded material transported in a predetermined transporting direction by a transport belt is known. The related art as described above is configured to detect marks recorded regularly on the recorded material by a sensor arranged in the proximity of a recording head, and drive the recording head on the basis of the detected timing. Accordingly, the dot formation timing by the recording head is synchronized with the transported position of the recorded material (see JP-A-10-151774).

However, in the related art disclosed in JP-A-11-245383, the recording head is driven synchronously with a detected signal of the linear scale attached to the transport belt. Therefore, when there arises a transport error caused by slippage between the transport belt and the recorded material, the dot formation timing by the recording head might be deviated from the actual transported positions of the recorded material. Therefore, the related art disclosed in above-described JP-A-11-245383 might suffer from lowering of recording accuracy caused by the slippage between the transport belt and the recorded material.

In contrast, in the related art disclosed in JP-A-10-151774, the recording head is driven synchronously with the detected signals of the marks recorded on the recorded material. Therefore, even though the transport error caused by the slippage between the transport belt and the recorded material occurs, the dot formation timing by the recording head is not affected in terms of the relation with respect to the positions of the marks.

However, in the related art disclosed in JP-A-10-151774, the cycle of recording the marks on the recorded material is determined on the basis of output signals of a rotary encoder device provided on a motor which drives the transport belt. Therefore, when there arises a transport error caused by the slippage between the transport belt and the recorded material, the marks might be formed at positions deviated from positions where the marks are supposed to be formed.

In other words, in the related art disclosed in the above described JP-A-10-151774, the pitch of the marks which should serve as references for synchronizing the dot formation timing by the recording head with the transported positions of the recorded material might not be a regular pitch. Therefore, the dot formation timing by the recording head with respect to the actual transported positions of the recorded material might be deviated due to the positional deviance of the marks. In addition, in the same manner as the related art disclosed in JP-A-11-245383, it might suffer from lowering of the recording accuracy caused by the slippage between the transport belt and the recorded material.

### SUMMARY

An advantage of some aspects of the invention is to improve the recording accuracy in the recording apparatus by synchronizing the dot formation timing of the recording head with the transported position of the recorded material with a high degree of accuracy.

According to a first aspect of the invention there is provided a reference mark forming device configured to form reference marks on a recorded material to be transported in a predetermined transporting direction by a transporting device at a predetermined regular pitch in the transporting direction including: a reference-mark-specific head configured to form the reference marks on the recorded material transported by the transporting device; a mark detection sensor configured to detect the reference marks formed on the recorded material by the reference-mark-specific head on the downstream side of the reference-mark-specific head in terms of the transporting direction; and a head drive unit configured to drive the reference-mark-specific head on the basis of an output signal from the mark detection sensor, in which the reference-mark-specific head and the mark detection sensor are arranged so that the relative positional relation is maintained constant, and the head drive unit forms the subsequent reference mark on the basis of the position of the reference mark detected by the mark detection sensor.

The mark detection sensor detects the reference mark recorded on the recorded material, and the head drive unit drives the reference-mark-specific head on the basis of the output signal from the mark detection sensor, whereby the reference mark is formed on the recorded material. In other words, the driving timing of the reference-mark-specific head is determined on the basis of the position of the reference marks formed on the recorded material. Therefore, on the recorded material transported by the transporting device, the subsequent reference marks are formed in sequence with a predetermined pitch on the basis of the position of the reference marks formed on the recorded material. Accordingly, the reference marks are formed in sequence with the predetermined regular pitch in the transporting direction with being little affected by a transport error caused by slippage of the recorded material in the transporting device. In addition, since the relative positional relation between a mark forming element of the reference-mark-specific head and the mark detection sensor is always maintained constant, the reference marks are formed with the regular pitch with an extremely high degree of accuracy.

When executing recording on the recorded material by a recording apparatus, the dot formation timing of a recording head is brought into sync with the reference marks formed on the recorded material by the reference mark forming device. Since the reference marks formed on the recorded material by the reference mark forming device according to the present invention are formed with the regular pitch with an extremely high degree of accuracy, the execution of recording while bringing the dot formation timing of the recording head into sync with the transported position of the recorded material with a high degree of accuracy is achieved.

The timing of formation of the reference marks on the recorded material may be of any timing as long as it is a constant timing with reference to a time point when the mark detection sensor detects the reference mark. For example, it may be a timing when a certain time period is elapsed from the time point when the mark detection sensor detects the reference mark. For example, it may be the timing when the recorded material is transported by a certain amount from the time point when the mark detection sensor detects the reference mark. However, in order to avoid the effect of the transport error caused by the slippage of the recorded material in the transporting device as much as possible, it is most preferable to set a time point when the mark detection sensor detects the reference mark as the reference mark formation timing.

Also, the timing to form the first reference mark on the recorded material may be determined in reference to the position of a leading edge of the recorded material in the transporting direction. For example, the position of the leading edge of the recorded material in the transporting direction is detected, and the reference-mark-specific head is driven at the timing when the first reference mark is formed at a predetermined distance from the position of the leading edge. The position of the leading edge of the printed material in the transporting direction may be detected, for example, by the mark detection sensor. Alternatively, the position of the leading edge of the recorded material in the transporting direction may be detected by providing a sensor specific for detecting the position of the leading edge of the printed material separately. Alternatively, the position of the leading edge of the recorded material in the transporting direction may be determined using the output signal from a printed material detection sensor or the like provided in the recording apparatus.

Accordingly, with the reference mark forming device disclosed in the first embodiment of the invention, an advantage such that the improvement of the recording accuracy is achieved by bringing the dot formation timing of the recording head into sync with the transported position of the recorded material at a high degree of accuracy in the recording apparatus having the reference mark forming device.

Preferably, the reference-mark-specific head includes a plurality of the mark forming elements disposed at the predetermined regular pitch in the transporting direction, and the head drive unit drives at least two mark forming elements from among the plurality of mark forming elements simultaneously to form two or more reference marks simultaneously.

In this configuration, by driving the plurality of mark forming elements disposed on the reference-mark-specific head simultaneously, simultaneous formation of the plurality of reference marks on the recorded material at a pitch of arrangement of the plurality of mark forming elements is achieved. In other words, since the pitch of the plurality of mark forming elements are always the unchanged predetermined pitch, the plurality of reference marks maybe formed with the predetermined pitch with an extremely high degree of accuracy. Accordingly, the accuracy of the formation of the reference marks on the recorded material is further improved, and hence the recording accuracy of the recording apparatus provided with the reference mark forming device is further improved.

The timing to form the reference marks in this configuration may be determined on the basis of the output signal from the mark detection sensor. For example, the timing may be determined so that the distance between the rearmost reference mark in the reference mark row formed at the previous timing and the frontmost reference mark of the reference mark row to be formed at the timing in question becomes the predetermined distance. In other words, the timing may be determined so that the distance between the rearmost reference mark in the reference mark row formed at the previous timing and the frontmost reference mark of the reference mark row to be formed at the timing in question becomes the pitch of arrangement of the plurality of mark forming elements.

According to a second aspect of the invention, there is provided a reference mark-specific-head module including the reference-mark-specific head and the mark detection sensor according to the first aspect of the invention, in which the reference-mark-specific head and the mark detection sensor are arranged so that the relative positional relation is maintained constant.

In this configuration, in the reference mark forming device provided with the reference-mark-specific head module, the same advantages as in the configurations described above are obtained.

According to a third aspect of the present invention, there is provided a recording apparatus including: a transporting device configured to transport a recorded material in a predetermined transporting direction; a recording head configured to form a dot on a recording surface of the recorded material transported by the transporting device; a reference mark sensor arranged in the proximity of the recording head and detecting a reference mark; a control device configured to control the dot formation timing of the recording head on the basis of a reference mark detection signal outputted from the reference mark sensor; and the reference mark forming device according to the first aspect of the invention.

In this configuration, the same advantages as the configurations as described above are achieved in the recording apparatus.

Preferably, the recording apparatus according to the third aspect of the invention includes: an inclination detection sensor configured to detect inclination of the recorded material transported by the transporting device with respect to the transporting direction; and an inclination angle adjusting device configured to adjust the inclination angle of the reference mark forming device with respect to the transporting direction, wherein the control device controls the inclination angle adjusting device on the basis of an output signal from the inclination detection sensor.

In this configuration, since the formation of the reference marks obliquely with respect to the recorded material is prevented in advance, the lowering of the recording accuracy caused thereby is prevented in advance.

Preferably, the recording apparatus according to the third aspect of the invention includes: a position detection sensor configured to detect a position in the direction intersecting the transporting direction of the recorded material transported by the transporting device; and a position adjusting device configured to displace the reference mark forming device in the direction intersecting the transporting direction, in which the control device controls the position adjusting device on the basis of an output signal from the position detection sensor.

In this configuration, since the formation of the reference marks at a position deviated from the position where the reference mark should originally be formed with respect to the recorded material is prevented in advance, the lowering of the recording accuracy caused thereby is prevented in advance.

### BRIEF DESCRIPTION OF THE DRAWINGS

The invention will be described with reference to the accompanying drawings, wherein like numbers reference like elements.

FIG. 1 is a plan view of a principal portion of an ink jet printer.

FIG. 2 is a side view of the principal portion of the ink jet printer.

FIG. 3 is a block diagram showing a configuration of a reference dot forming device according to a first embodiment.

FIG. 4 is a plan view schematically showing a procedure for forming reference dots according to the first embodiment.

FIG. 5 is a plan view schematically showing a procedure for detecting the reference dots by a dot detection sensor.

FIGS. 6A and 6B show a flowchart of a control procedure for forming the reference dots on a recording surface of a recording paper.

FIG. 7 is a plan view schematically showing a procedure for forming the reference dots according to a second embodiment.

FIG. 8 is a block diagram showing a configuration of the reference dot forming device according to a third embodiment.

FIGS. 9A and 9B are plan views of a principal portion of the ink jet printer according to a fourth embodiment.

FIGS. 10A and 10B are plan views of a principal portion of the ink jet printer according to the fourth embodiment.

### DESCRIPTION OF EXEMPLARY EMBODIMENTS

Referring now to drawings, embodiments of the invention will be described below. The invention is not limited to the embodiment described below, and various modifications are possible within the scope of the invention claimed in attached claims and such modifications are also included within the scope of the invention as a matter of course.

### Schematic Configuration of Ink Jet Printer

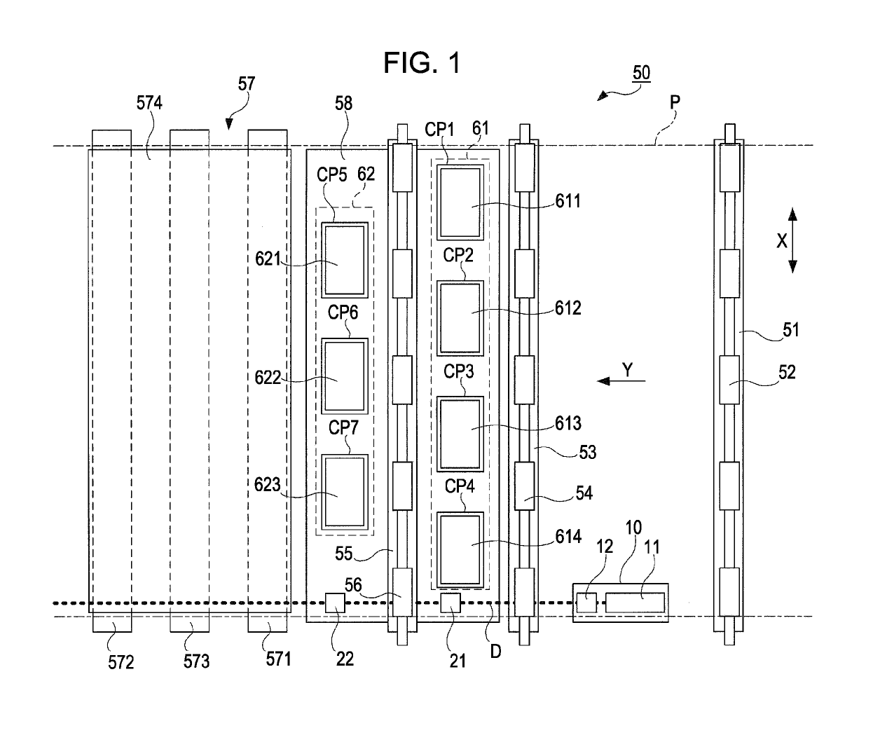

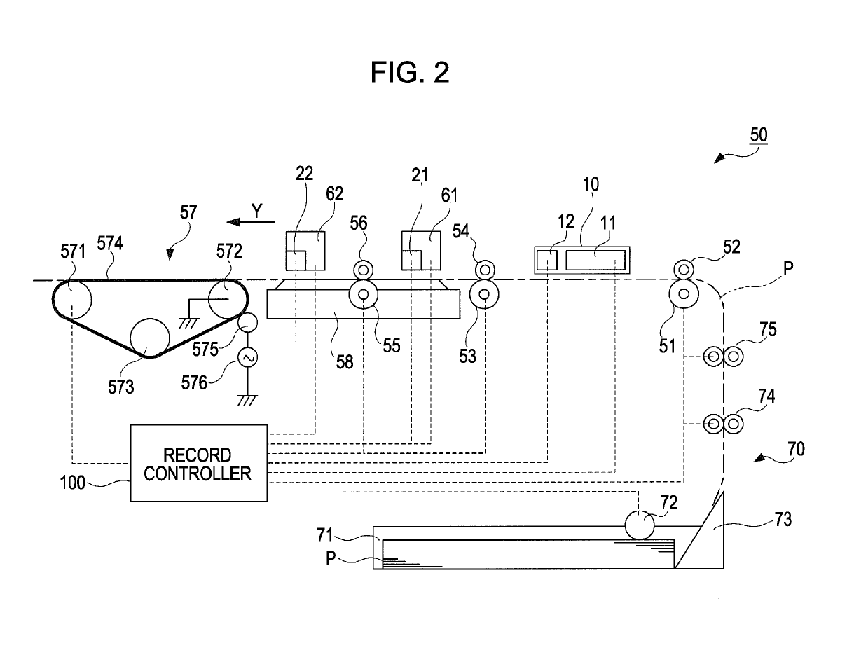

Referring now to FIGS. 1 and 2, a schematic configuration of an ink jet printer 50 as a “recording apparatus” in the invention will be described.

FIG. 1 is a plan view of a principal portion of the ink jet printer 50, and FIG. 2 is a side view of the principal portion.

The ink jet printer 50 according to the present invention is so-called a line-head type ink jet printer. The ink jet printer 50 includes an automatic document feeder 70 configured to deliver a recording paper P as a “recorded material” to the interior of the ink jet printer 50. The ink jet printer 50 includes a first transport drive roller 51 which constitutes a “transporting device” configured to transport the recording paper P in a transporting direction Y, a first transport driven roller 52, a second transport drive roller 53, a second transport driven roller 54, an intermediate drive roller 55, an intermediate driven roller 56, and a discharging device 57. Furthermore, the ink jet printer 50 is provided with a first recording head row 61 and a second recording head row 62 configured to execute recording by forming dots on a recording surface of the recording paper P to be transported in the transporting direction Y in a state of being supported by a platen 58.

The automatic document feeder 70 includes a delivery cassette 71, a delivery roller 72, a guiding bevel 73, and delivery intermediate roller pairs 74 and 75. The delivery cassette 71 is configured to store the plurality of recording papers P in a state of being stacked one on top of another. The delivery roller 72 is rotated by a rotation driving force of a motor, not shown. The guiding bevel 73 is a bevel surface for guiding a leading edge of the recording paper P to a nip point of the delivery intermediate roller pair 74. The delivery intermediate roller pairs 74 and 75 are roller pairs each including a drive roller driven by the rotation driving force of the motor, not shown, and a rotatably supported driven roller.

An uppermost recording paper P from among the recording papers P stacked on the delivery cassette 71 comes into abutment with an outer peripheral surface of the delivery roller 72. The uppermost recording paper P in the delivery cassette 71 is delivered to the nip point of the delivery intermediate roller pair 74 along the guiding bevel 73 by the rotation of the delivery roller 72. Then, the recording paper P moves forward along a delivery path by the delivery intermediate roller pair 74 and 75 and is delivered to a position where the leading edge thereof reaches the nip point between the first transport drive roller 51 and the first transport driven roller 52.

The first transport drive roller 51, the second transport drive roller 53, and the intermediate drive roller 55 are provided with a high-friction coating applied on the surfaces thereof, and rotate by the transmission of the rotation driving force of the motor, not shown. The first transport driven roller 52 is supported so as to be rotated, and comes into abutment with an outer peripheral surface of the first transport drive roller 51 by an urging force of an urging device such as a spring, not shown. The second transport driven roller 54 is supported so as to be rotated, and comes into abutment with an outer peripheral surface of the second transport drive roller 53 by an urging force of an urging device such as a spring, not shown. The intermediate driven roller 56 is supported so as to be rotated, and comes into abutment with an outer peripheral surface of the intermediate drive roller 55 by an urging force of an urging device such as a spring, not shown. The recording paper P delivered by the automatic document feeder 70 is transported on the platen 58 in the transporting direction Y by the driven rotation of the first transport drive roller 51, the second transport drive roller 53 and the intermediate drive roller 55.

The first recording head row 61 is disposed between the second transport drive roller 53 and the intermediate drive roller 55, and includes recording heads 611 to 614 arranged in a widthwise direction X (the direction interesting the transporting direction Y) with a regular pitch. The second recording head row 62 is disposed on the downstream side of the intermediate drive roller 55 in the transporting direction Y, and includes recording heads 621 to 623 arranged in the widthwise direction X with a regular pitch. The recording head 621 is disposed at a position corresponding to a position between the recording head 611 and the recording head 612. In the same manner, the recording head 622 is disposed at a position corresponding to a position between the recording head 612 and the recording head 613. In the same manner, the recording head 623 is arranged at a position corresponding to a position between the recording head 613 and the recording head 614. The recording heads 611 to 614 and 621 to 623 each include a number of ink ejecting nozzles (not shown) for ejecting ink on a head surface opposing the platen 58.

The platen 58 is disposed at a position opposing the first recording head row 61 and the second recording head row 62, and supports the recording paper P transported in the transporting direction Y from the back surface side. A distance between the head surfaces of the recording heads 611 to 614, and 621 to 623 and a recording surface of the recording paper P is defined by the platen 58. The platen 58 is provided with caps CP1 to CP7 corresponding respectively to the recording heads 611 to 614, and 621 to 623. The caps CP1 to CP7 are disposed so as to be capable of moving in the vertical direction by a drive mechanism, not shown. The caps CP1 to CP7 rise when in the waiting state and seal the head surfaces of the recording heads 611 to 614, and 621 to 623. Accordingly, clogging of the nozzles by the solidification of the ink at the ink ejecting nozzles is prevented. The caps CP1 to CP7 also serve as ink throw-away holes at the time of recording of, so-called, a borderless recording or at the time of preliminary ejection before the recording.

The discharging device 57 includes a drive roller 571, a driven roller 572, a tension roller 573, a transport belt 574, a charged roller 575, and a charging device 576. The drive roller 571 is rotated by a rotation driving force of a motor, not shown. The driven roller 572 is supported so as to be rotated in a state of being electrically grounded. The transport belt 574 is wound around the drive roller 571, the driven roller 572, and the tension roller 573 as shown in the drawing. The transport belt 574 is provided with a predetermined tension by the tension roller 573. The charged roller 575 is supported so as to be rotated and is disposed at a position to come into contact with an outer peripheral surface of the transport belt 574 and catch the transport belt 574 with the driven roller 572 therebetween. The charging device 576 is a device to apply an AC voltage of a predetermined frequency to the charged roller 575.

The discharging device 57 configured as described above forms alternate charge patterns on the transport belt 574 at the nip point between the driven roller 572 and the charged roller 575. The recording paper P after having recorded thereon is adhered to the transport belt 574 by the electrostatic adhesion, and is discharged by the transport belt 574 rotating in the transporting direction Y.

In addition, the ink jet printer 50 includes a reference dot forming device 10 as a “reference mark forming device” and a first reference dot sensor 21 and a second reference dot sensor 22 as “reference mark sensors”.

The reference dot forming device 10 is disposed on a transport path between the first transport drive roller 51 and the second transport drive roller 53. The reference dot forming device 10 forms reference dots D as “reference marks” with a predetermined regular pitch in the transporting direction Y on the recording paper P transported in the transporting direction Y. The first reference dot sensor 21 and the second reference dot sensor 22 are sensors configured to detect the reference dots D formed on the recording paper P by the reference dot forming device 10. The first reference dot sensor 21 is arranged in the proximity of the first recording head row 61. The second reference dot sensor 22 is arranged in the proximity of the second recording head row 62.

A record controller 100 as a “control device” having a microcomputer control circuit performs delivery control and transport control of the recording paper P. The record controller 100 also controls the dot formation timing of the first recording head row 61 and the second recording head row 62. The dot formation timing of the first recording head row 61 is controlled on the basis of reference dots D detection signals outputted by the first reference dot sensor 21. The dot formation timing of the second recording head row 62 is controlled on the basis of reference dots D detection signals outputted by the second reference dot sensor 22. In addition, the record controller 100 controls the reference dots D formation timing of the reference dot forming device 10.

### First Embodiment

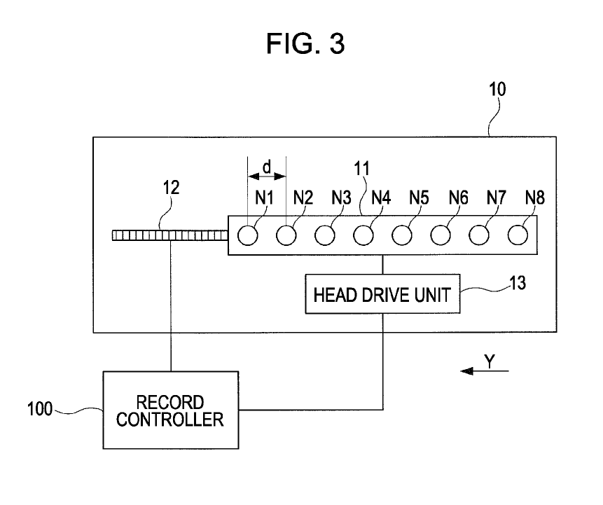

Referring now to FIG. 3 to FIG. 6, a first embodiment of the present invention will be described.

First of all, referring to FIG. 3, a configuration of the reference dot forming device 10 according to the embodiment of the present invention provided on the ink jet printer 50 will be described.

FIG. 3 is a block diagram showing the configuration of the reference dot forming device 10 according to the first embodiment.

The reference dot forming device 10 according to the embodiment of the invention includes a reference-dot-specific head 11 as a “reference-mark-specific head”, and a dot detection sensor 12 and a head drive unit 13 as “mark detection sensors”.

The reference-dot-specific head 11 forms the reference dots D by ejecting ink on the recording surface of the recording paper P transported in the transporting direction Y. The reference-dot-specific head 11 has eight ink ejecting nozzles N1 to N8 (mark forming elements) as dot forming elements disposed in the transporting direction Y at a predetermined regular nozzle pitch d. The number of the ink ejecting nozzles described here is specified as an example only, and is not limited to eight, and the invention may be implemented with any number of ink ejecting nozzles. The nozzle pitch d may be set to a given pitch according to a recording resolution required by the ink jet printer 50. For example, the nozzle pitch d in this embodiment is set to 180 dpi (dot per inch).

The dot detection sensor 12 is arranged in the proximity of the reference-dot-specific head 11. The dot detection sensor 12 is a sensor configured to detect the reference dots D formed on the recording surface of the recording paper P by the reference-dot-specific head 11 and the leading edge of the recording paper P in the transporting direction Y. Output signals from the dot detection sensor 12 are inputted to the record controller 100 in the first embodiment. Although the dot detection sensor 12 in the first embodiment is a line sensor disposed in the transporting direction Y, it may be an area sensor, for example. As the dot detection sensor 12, sensors of any type are applicable as long as it has a capability of identifying the reference dots D formed on the recording surface of the recording paper P. For example, so called a CCD (Charge Coupled Device) image sensor or a CMOS (Complementary Metal Oxide Semiconductor) image sensor, or a PSD (Position Sensitive Detector) are preferable. Also, the dot detection sensor 12 is preferably disposed via an adjusting mechanism (not shown) which has a capability of making a fine adjustment of the positional relation with respect to the reference-dot-specific head 11 in the manufacturing process or the maintenance operation.

The head drive unit 13 is configured to drive the ink ejecting nozzles N1 to N8 of the reference-dot-specific head 11 on the basis of the output signals from the dot detection sensor 12. The head drive unit 13 is controlled by the record controller 100 in the first embodiment. Although the head drive unit 13 is mounted in the interior of the reference dot forming device 10 in this embodiment, the reference dot forming device 10 in the invention is not limited to this configuration. For example, a configuration such that the reference-dot-specific head 11 and the dot detection sensor 12 are configured as a single module (reference-dot-specific head module), and the head drive unit 13 is disposed at a position apart therefrom as a separate component is also applicable. At this time, input/output signal lines with respect to the reference-dot-specific head 11 and the dot detection sensor 12 may be connected with cables or the like. In this case, the head drive unit 13 may be mounted on the record controller 100 of the ink jet printer 50. Alternatively, the reference-dot-specific head 11 may be driven using head drivers (not shown) of the recording heads 611 to 614, and 621 to 623 without providing the head drive unit 13.

The ink ejected from the reference-dot-specific head 11 may be ink of any type as long as it allows the dot detection sensor 12, the first reference dot sensor 21 and the second reference dot sensor 22 to detect the reference dots D formed therewith by being ejected on the recording surface of the recording paper P. For example, black ink or the like used in the ink jet printer 50 may also be used. Alternatively, the reference dots D may be formed with transparent and colorless UV visible ink, for example. In this case, detection of the reference dots D by the dot detection sensor 12, the first reference dot sensor 21 and the second reference dot sensor 22 is enabled by irradiating the reference dots D with UV light.

Supply of ink to the reference-dot-specific head 11 is achieved by demountably mounting a compact ink cartridge (not shown), for example, in the reference dot forming device 10, so as to allow the ink to be supplied from the ink cartridge to the reference-dot-specific head 11. Alternatively, a configuration such that the ink is supplied from the ink cartridge or an ink tank provided in the ink jet printer 50 to the reference-dot-specific head 11 via an ink tube is also applicable.

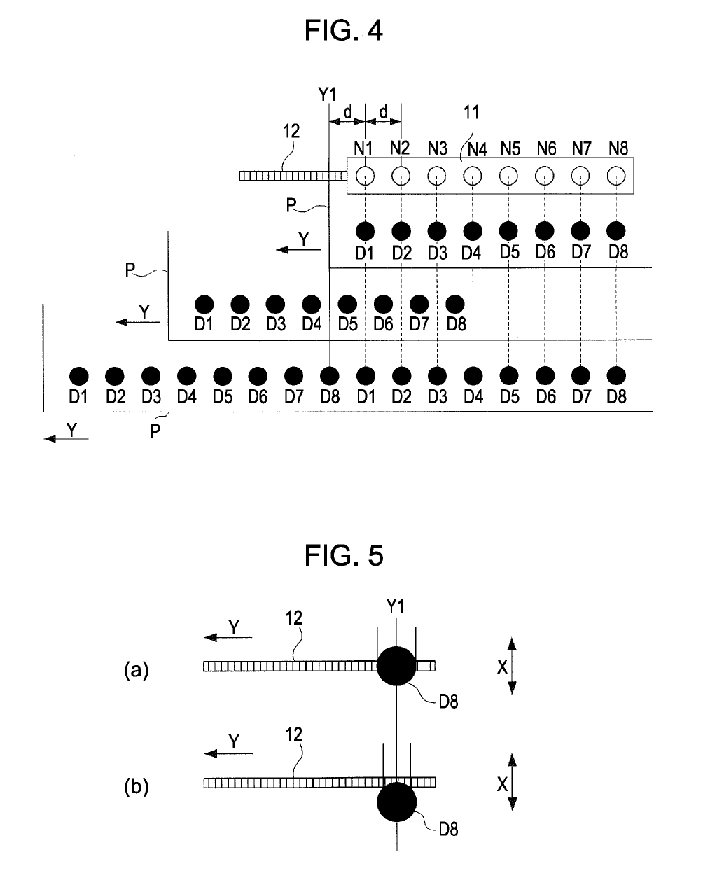

Referring now to FIG. 4 to FIG. 6, control of formation of the reference dots D by the reference dot forming device 10 will be described.

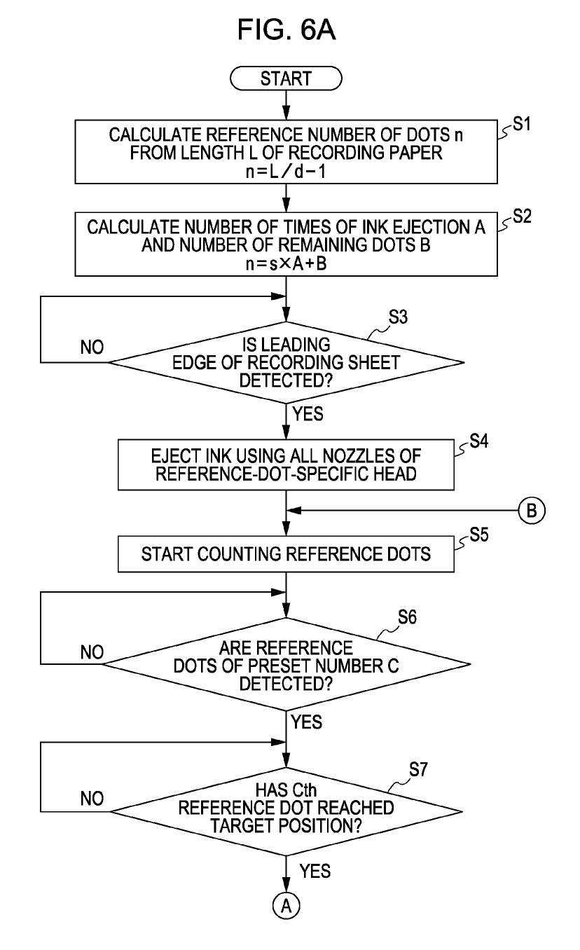

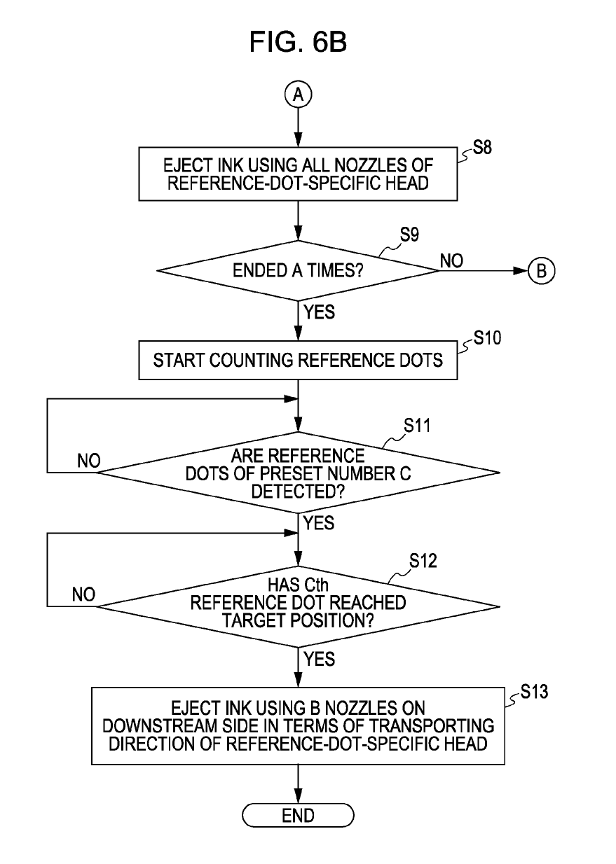

FIG. 4 is a plan view schematically showing a procedure for forming the reference dots D on the recording surface of the recording paper P according to the first embodiment. FIG. 5 is a plan view schematically showing a procedure for detecting the reference dots D formed on the recording surface of the recording paper P by the dot detection sensor 12. FIGS. 6A and 6B show a flowchart of a control procedure for forming the reference dots D on the recording surface of the recording paper P.

Referring now to FIG. 4 and FIG. 5 as needed, the control procedure for forming the reference dots D on the recording surface of the recording paper P by the ink jet printer 50 according to the embodiment of the invention according to the flowchart shown in FIGS. 6A and 6B will be described.

First of all, a length L of the transporting direction Y of the recording paper P delivered from the automatic document feeder 70 is determined from the size of the recording paper P set by a user on a menu window or the like of a printer driver. Then, the number of the reference dots “n” to be recorded on the recording paper P is calculated from the length L of the determined recording paper P. More specifically, the number of the reference dots “n” is calculated by the following expression (1) (Step S1).

Number of Reference Dots n=L/d−1 (1)

Reference sign d in the expression (1) designates the nozzle pitch of the reference-dot-specific head 11.

Subsequently, the number of times of all-nozzle ejection A of the reference-dot-specific head 11 required for forming n-pieces of the reference dots D on the recording paper P and the number of remaining dots B are calculated. The number of times of all-nozzle ejection A and the number of remaining dots B are calculated by the following expression (2) in detail (Step S2).

Number of Reference Dots n=s×A+B (2)

Reference sign s in the expression (2) designates the number of ink ejecting nozzles of the reference-dot-specific head 11. In this embodiment, s is “8” (s=8). Therefore, for example, when the number of reference dots “n” to be recorded on the recording paper P is “900” (n=900), the number of times of all-nozzle ejection A is “112” (A=112), and the number of remaining dots B is “4” (B=4).

Subsequently, whether or not the leading edge of the delivered recording paper P in the transporting direction Y is detected by the dot detection sensor 12 is determined. More specifically, whether or not the leading edge of the recording paper P has reached a target position Y1 in the range of detection of the dot detection sensor 12 is determined (Step S3). In order to detect the leading edge of the white recording paper P with the dot detection sensor 12 with higher degree of accuracy, for example, formation of the platen 58 of a black member is recommended.

The target position Y1 is set in this embodiment so that the distance with respect to the ink ejecting nozzle N1 corresponds to the nozzle pitch d (FIG. 4). Then, at a time point when the leading edge of the recording paper P reaches the target position Y1 (Yes in Step S3), the ink is ejected simultaneously from the ink ejecting nozzles N1 to N8 of the reference-dot-specific head 11 (Step S4). In other words, the all-nozzle ejection for the first time is executed. Accordingly, eight reference dots D1 to D8 are formed with the nozzle pitch d of the reference-dot-specific head 11 simultaneously on the recording surface of the recording paper P (FIG. 4).

The position of the leading edge of the recording paper P in the transporting direction Y may be determined by using output signals from a sheet detector 33 or a PW sensor 34 provided in the ink jet printer 50.

Subsequently, the reference dots D1 to D8 formed on the recording surface of the recording paper P are detected in sequence by the dot detection sensor 12 (Step S5), and whether or not the reference dots D of the preset number C is detected (counted) is determined (Step S6). In this embodiment, the number C is set to “8” (C=8). Therefore, in Step S5, whether or not the eight reference dots D has been counted is determined. When the eighth reference dot D8 is counted, that is, when the rearmost reference dot D8 of the reference dot row having eight reference dots D is detected (Yes in Step S6), whether or not the eighth reference dots D8 has reached the target position Y1 is determined (Step S7). At a time point when the eighth reference dot D8 has reached the target position Y1 (Yes in Step S7), the ink is ejected simultaneously from the ink ejecting nozzles N1 to N8 of the reference-dot-specific head 11 (Step S8). In other words, the all-nozzle ejection for the second time is executed. Accordingly, the next eight reference dots D1 to D8 are formed on the recording surface of the recording paper P simultaneously from the position at a distance equal to the nozzle pitch d from the rearmost reference dot D8 of the reference dot row formed so far on the upstream side in the transporting direction Y as an initial position (FIG. 4).

Then, detection of the time point when the rearmost eighth reference dot D8 has reached the target position Y1 is preferably the time point when the center point of the rearmost reference dot D8 reaches the target position Y1. More specifically, it may be set to a time point when a position which divides the distance of the reference dot D8 between a downstream end detecting position and an upstream end detecting position in the transporting direction Y into half reaches the target position Y1 (FIG. 5(a)). It is determined as a result of consideration of the fact that the size of the reference dots D may not be strictly uniform, and may slightly vary, and the fact that the center position of the rearmost reference dot D8 with respect to the dot detection sensor 12 may be deviated relatively in the widthwise direction X (FIG. 5(b)). In other words, if the timing of formation of the next reference dot row is determined to be the time point when the upstream end or the downstream end of the reference dot D8 in the transporting direction Y reaches the target position Y1, the accuracy of formation of the reference dots D might be lowered due to the above-described reasons.

Subsequently, whether or not the number of times of execution of the all-nozzle ejection reaches the number of times of all-nozzle ejection A is determined (Step S9). When the number of times of execution of the all-nozzle ejection does not reach the number of times of all-nozzle ejection A (No in Step S9), the procedure from Steps S5 to S8 is executed repeatedly. Then, at the time point when the number of execution of the all-nozzle ejection reaches the number of times of all-nozzle ejection A (Yes in Step S9), 8×112=896 pieces of reference dots D are formed on the recording surface of the recording paper P with the regular nozzle pitch d in the transporting direction Y. Therefore, in order to form 900 pieces of reference dots D on the recording surface of the recording paper P, only four more reference dots D have to be formed continuously with the nozzle pitch d.

When the number of times of execution of the all-nozzle ejection reaches the number of times of all-nozzle ejection A (Yes in Step S9), the reference dots D1 to D8 formed on the recording surface of the recording paper P are detected in sequence by the dot detection sensor 12 in the same procedure as Steps S5 to S7 (Step S10). When the eighth reference dot D8 is detected (Yes in Step S11), whether or not the eighth reference dot D8 has reached the target position Y1 described above is determined (Step S12). Then, at the time point when the eighth reference dot D8 has reached the target position Y1 (Yes in Step S12), remaining reference dots D are formed using the ink ejecting nozzles of the number corresponding to the number of remaining dots B (four). More specifically, the ink is ejected simultaneously from the ink ejecting nozzles N1 to N4 on the downstream side in the transporting direction Y to form the remaining reference dots D1 to D4 (Step S13).

In this manner, according to the ink jet printer 50 in the embodiment of the invention, the drive timing of the reference-dot-specific head 11 is determined on the basis of the positions of the reference dots D formed on the recording paper P. Therefore, on the recording paper P transported in the transporting direction Y by the first transport drive roller 51 or the like, the subsequent reference dots D are formed in sequence with a predetermined pitch on the basis of the positions of the reference dots D formed on the recording paper P. Accordingly, the reference dots D are formed in sequence with the regular nozzle pitch d in the transporting direction Y with being little affected by the transport error caused by the slippage of the recording paper P in the first transport drive roller 51. The reference-dot-specific head 11 and the dot detection sensor 12 are fixed to constant positions, respectively. Accordingly, the relative positions between the ink ejecting nozzles N1 to N8 of the reference-dot-specific head 11 and the dot detection sensor 12 are constantly maintained. Therefore, the reference dots D are formed with the regular pitch with an extremely high degree of accuracy.

Then, the record controller 100 brings the dot formation timings by the first recording head row 61 and the second recording head row 62 into sync with the reference dots D formed on the recording surface of the recording paper P. More specifically, the reference dots D formed on the recording surface of the recording paper P are detected by the first reference dot sensor 21 and the second reference dot sensor 22. Pulse signals synchronous with the pitch of the reference dots D are outputted from the first reference dot sensor 21 and the second reference dot sensor 22. The ink ejecting nozzles of the respective recording heads 611 to 614 of the first recording head row 61 are driven synchronously with the pulse signals outputted from the first reference dot sensor 21 arranged in the proximity of the first recording head row 61. In the same manner, the ink ejecting nozzles of the respective recording heads 621 to 623 of the second recording head row 62 are driven synchronously with the pulse signals outputted from the second reference dot sensor 22 arranged in the proximity of the second recording head row 62.

Since the reference dots D formed on the recording surface of the recording paper P are formed with the regular pitch with an extremely high degree of accuracy, execution of recording while bringing the dot formation timings by the first recording head row 61 and the second recording head row 62 into sync with the transported position of the recording paper P with a high degree of accuracy is achieved. Also, depending on the characteristics of the recording paper P, the recording paper P might shrink by being moistened with ink until an area formed with dots by the ink ejected thereon from the first recording head row 61 reaches the second recording head row 62. However, the dots are formed at accurate positions while following the shrinkage of the recording paper P as described above.

As described thus far, according to the embodiment of the invention, improvement of the recording accuracy is achieved by bringing the dot formation timings of the first recording head row 61 and the second recording head row 62 into sync with the transported position of the recording paper P with a high degree of accuracy.

In the reference dot forming device 10 in the embodiment of the invention, preferably, the plurality of the ink ejecting nozzles N1 to N8 are disposed on the reference-dot-specific head 11 with a constant nozzle pitch d and the plurality of ink ejecting nozzles N1 to N8 are driven simultaneously to form the plurality of reference dots D1 to D8 simultaneously. The pitch of the plurality of ink ejecting nozzles N1 to N8 is constantly unchanged from the nozzle pitch d, the plurality of reference dots D1 to D8 may be formed with the nozzle pitch d with an extremely high degree of accuracy. Accordingly, the accuracy of formation of the reference dots D with respect to the recording paper P is further improved, and hence the accuracy of recording in the ink jet printer 50 is further improved.

### Second Embodiment

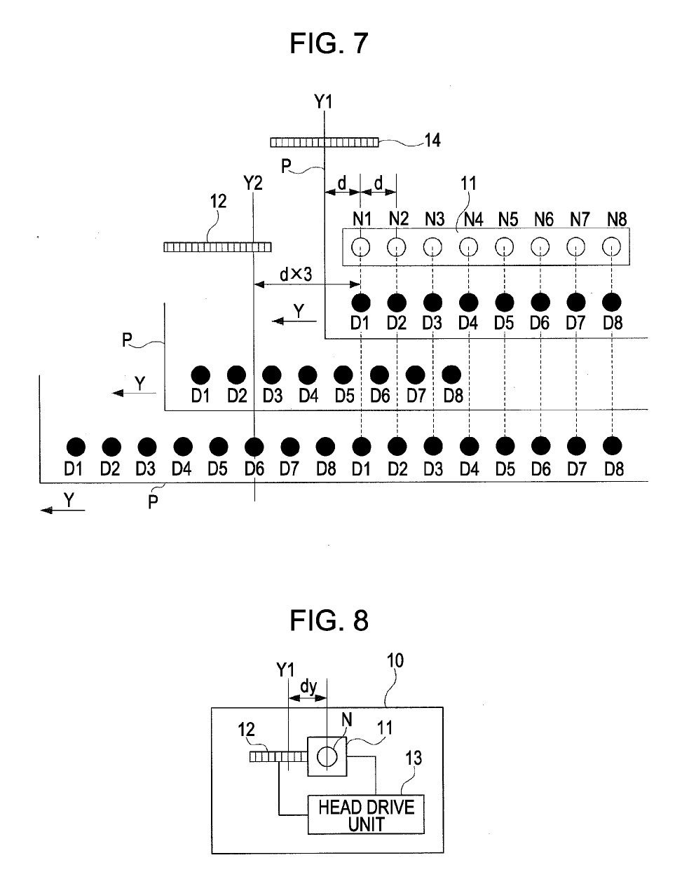

Referring now to FIG. 7, a second embodiment will be described.

FIG. 7 is a plan view schematically showing a procedure for forming the reference dots D on the recording surface of the recording paper P according to the second embodiment.

In the reference dot forming device 10 in the second embodiment, the dot detection sensor 12 is arranged at a position farther from the reference-dot-specific head 11 than in the first embodiment. Also, the distance of the target position Y2 in the range of detection of the dot detection sensor 12 from the ink ejecting nozzle N1 is set to be at a distance corresponding to three times the nozzle pitch d. In addition, the reference dot forming device 10 in the second embodiment includes a leading edge position sensor 14 for detecting the position of the leading edge of the recording paper P in the transporting direction Y. The target position Y1 in the range of detection of the leading edge position sensor 14 is set in such a manner that the distance from the ink ejecting nozzle N1 becomes a distance corresponding to the nozzle pitch d as in the case of the target position Y1 in the first embodiment. The leading edge position sensor 14 may be arranged at any position as long as the fact that the leading edge of the recording paper P in the transporting direction Y reaches the target position Y1 is detected. Therefore, as shown in the drawing, it can be arranged at a position shifted in the widthwise direction X from the same line in the transporting direction Y with respect to the ink ejecting nozzles N1 to N8 of the reference-dot-specific head 11.

The configuration of the ink jet printer 50 and the configuration of the reference dot forming device 10 other than those described above are the same as in the first embodiment and hence the description will be omitted.

Then, in the second embodiment, the reference dots D are formed on the recording surface of the recording paper P according to the flowchart shown in FIGS. 6A and 6B in the sequence described below.

Since the procedures of Steps S1 and S2 are completely the same as those in the first embodiment, description will be omitted. Subsequently, at the time point when the leading edge of the recording paper P reaches the target position Y1 in the range of detection of the leading edge position sensor 14 (Yes in Step S3), the ink is ejected from the ink ejecting nozzles N1 to N8 of the reference-dot-specific head 11 simultaneously to execute the all-nozzle ejection for the first time (Step S4).

Subsequently, the reference dots D1 to D8 formed on the recording surface of the recording paper P are detected in sequence by the dot detection sensor 12 (Step S5), and whether or not the reference dots D of the preset number C is detected (counted) is determined (Step S6). In this embodiment, the number C is set to “6” (C=6). Therefore, in Step S5, whether or not the six reference dots D has been counted is determined. In other words, when the sixth reference dot D6 from the top of the reference dot row including eight reference dots D is detected (Yes in Step S6), whether or not the sixth reference dots D6 has reached the target position Y2 is determined (Step S7).

As described above, the distance of the target position Y2 from the ink ejecting nozzle N1 is set to be a distance corresponding to three times the nozzle pitch d. Therefore, at a time point when the sixth reference dot D6 has reached the target position Y2 (Yes in Step S7), the ink is ejected simultaneously from the ink ejecting nozzles N1 to N8 of the reference-dot-specific head 11 (Step S8). In other words, the all-nozzle ejection for the second time is performed. Accordingly, the next eight reference dots D1 to D8 are formed simultaneously on the recording surface of the recording paper P from the position at a distance equal to the nozzle pitch d from the rearmost reference dot D8 of the reference dot row formed so far on the upstream side in the transporting direction Y as an initial position (FIG. 7).

The invention may be implemented in this mode, and the effects and advantages of the invention are achieved. In particular, according to the second embodiment, the distance of arrangement of the reference-dot-specific head 11 and the dot detection sensor 12 may be set to a large distance. Therefore, the second embodiment is significant in that the implementation of the invention is achieved even when the arrangement as in the first embodiment is physically difficult because the nozzle pitch d is extremely small distance for example. More specifically, first of all, a position on the downstream side from the downmoststream ink ejecting nozzle N1 in terms of the transporting direction Y by a distance obtained by multiplying the nozzle pitch d of the reference-dot-specific head 11 by a given integer (three in the second embodiment) (the position of the target position Y2) is determined. Then, the positional relation between the reference-dot-specific head 11 and the dot detection sensor 12 with respect to each other may be set so that the determined position is at least included in the range of detection of the dot detection sensor 12. The given integer is selected arbitrarily from integers (excluding zero) not larger than the number of ejection nozzles s of the reference-dot-specific head 11.

### Third Embodiment

Referring now to FIG. 8, a third embodiment will be described.

FIG. 8 is a block diagram showing the configuration of the reference dot forming device 10 according to the third embodiment.

The reference-dot-specific head 11 according to the third embodiment includes one ink ejecting nozzle N. In other words, the reference-dot-specific head 11 according to the third embodiment is different from the first embodiment and does not have the plurality of ink ejecting nozzles. In the reference-dot-specific head 11 according to the third embodiment, the output signals from the dot detection sensor 12 are entered directly to the head drive unit 13. In other words, in the reference dot forming device 10 according to the third embodiment, the head drive unit 13 is directly controlled by the output signals from the dot detection sensor 12.

Since the configurations other than those described above are the same as in the first embodiment, description will be omitted.

In the ink jet printer 50 provided with the reference-dot-specific head 11 according to the third embodiment, at the time point when the leading edge of the recording paper P reaches the target position Y1 in the range of detection of the dot detection sensor 12, the ink is ejected from the ink ejecting nozzle N. Accordingly, a first reference dot D is formed on the recording surface of the recording paper P. The reference dot D is formed at a position at a distance dy from the leading edge of the recording paper P.

Subsequently, at the time point when the reference dot D reaches the target position Y1, the ink is ejected from the ink ejecting nozzle N and a second reference dot D is formed on the recording surface of the recording paper P. The reference dot D is formed at a position at the distance dy from the first reference dot D. From then onward, a reference dot D is formed in sequence at the distance dy every time when the reference dot D reaches the target position Y1. The distance dy may be set to a given distance according to the recording resolution required by the ink jet printer 50 as the nozzle pitch d in the first embodiment and the second embodiment.

The invention may be implemented in this mode, and the effects and advantages of the invention are achieved. The reference dot forming device 10 in the third embodiment is operated independently without the intermediary of the record controller 100. In other words, the reference dot forming device 10 in the third embodiment functions as an independent unit. Therefore, for example, by adding the reference dot forming device 10 according to the third embodiment to an ink jet printer in the related art, the invention is implemented in the ink jet printer in the related art without changing the design. In addition, in the reference dot forming device 10 according to the third embodiment, for example, an enable terminal configured to switch the reference dot forming function to ON and OFF may be provided. Accordingly, control of the reference dot forming device 10 from the record controller 100 is also achieved.

### Fourth Embodiment

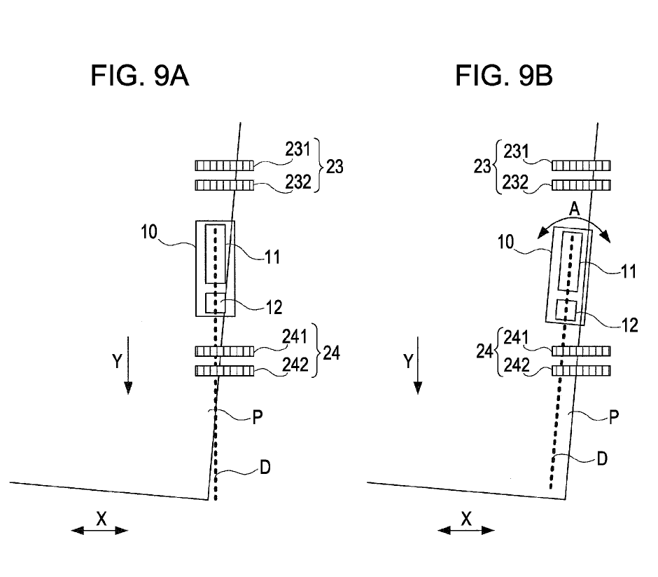

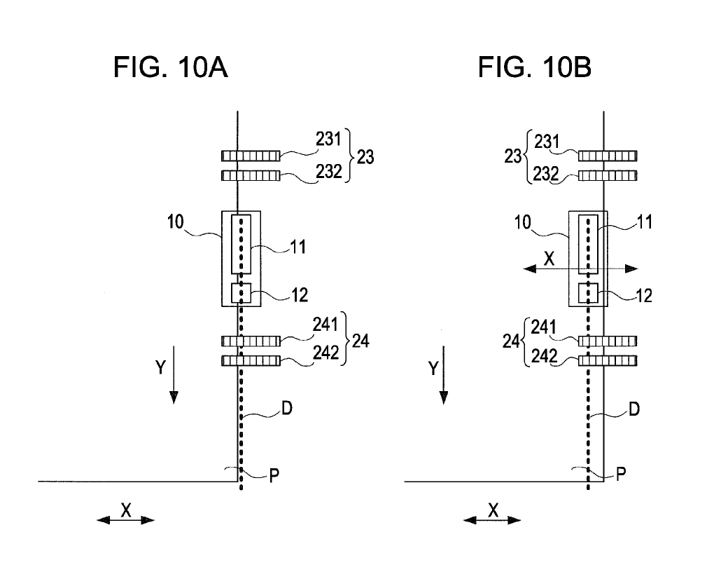

Referring now to FIG. 9 and FIG. 10, a fourth embodiment will be described.

FIGS. 9 and 10 are plan views of a principle portion of the ink jet printer 50 in the fourth embodiment.

A first sheet position detection sensor 23 is a sensor configured to detect the position in the widthwise direction X of the recording paper p in the transport path on the upstream side of the reference dot forming device 10 in terms of the transporting direction Y and the inclining angle (inclination detection sensor, position detection sensor).

A second sheet position detection sensor 24 is a sensor configured to detect the position in the widthwise direction X of the recording paper p in the transport path on the downstream side of the reference dot forming device 10 in terms of the transporting direction Y and the inclining angle (inclination detection sensor, position detection sensor).

The first sheet position detection sensor 23 includes line sensors 231 and 232 disposed apart from each other in terms of the transporting direction Y. In the same manner, the second sheet position detection sensor 24 includes line sensors 241 and 242 disposed apart from each other in terms of the transporting direction Y. The line sensors 231, 232, 241, and 242 are sensors arranged in the widthwise direction X and configured to be able to detect the edge of the recording paper P, which is so-called a CCD image sensor or a CMOS image sensor.

Since the configurations other than those described above are the same as the ink jet printer 50 in the first embodiment to the third embodiment, description will be omitted.

The ink jet printer 50 in the embodiment of the invention may also include an inclination angle adjusting device (not shown) configured to adjust the inclination angle of the reference dot forming device 10 in terms of the transporting direction Y in addition to any one of the first to third embodiments. For example, the reference dot forming device 10 is supported so as to be rotatable in the direction of rotation indicated by a reference sign A with respect to the ink jet printer 50. Then, a mechanism configured to rotate and displace the reference dot forming device 10 by a drive force of a motor or the like is provided. Accordingly, the inclination angle adjusting device configured to adjust the angle of inclination of the reference dot forming device 10 in terms of the transporting direction Y is realized. Alternatively, a device to rotate the recording paper P to correct the inclination of the recording paper P may be provided.

More specifically, first of all, the inclination angle of the recording paper P is detected by the first sheet position detection sensor 23 or the second sheet position detection sensor 24 (FIG. 9A). For example, the inclination angle and the direction of inclination of the recording paper P can be determined from a difference in side edge position of the recording paper P detected by the line sensor 231 and the side edge position of the recording paper P detected by the line sensor 232 of the first sheet position detection sensor 23. Then, the angle of rotation of the reference dot forming device 10 is adjusted so as to match the inclination angle and the direction of inclination of the detected recording paper P (FIG. 9B). Accordingly, since the formation of the reference dots D obliquely with respect to the recording paper P is prevented in advance, the lowering of the recording accuracy caused thereby is prevented in advance.

The ink jet printer 50 in the embodiment of the invention may also include a position adjusting device (not shown) configured to displace the reference dot forming device 10 in the widthwise direction X in addition to any one of the first to third embodiments. For example, the reference dot forming device 10 is supported so as to be displaceable in the widthwise direction X with respect to the ink jet printer 50. Then, a mechanism configured to displace the reference dot forming device 10 in the widthwise direction X by a drive force of a motor or the like is provided. Accordingly, the position adjusting device configured to displace the reference dot forming device 10 in the widthwise direction X is realized. Alternatively, a device to displace the recording paper P in the widthwise direction X may be provided.

More specifically, the position of the recording paper P in the widthwise direction X is detected by the first sheet position detection sensor 23 or the second sheet position detection sensor 24 (FIG. 10A). Then, the position of the reference dot forming device 10 in the widthwise direction X is adjusted according to the position of the detected recording paper P in the widthwise direction X (FIG. 10B). Accordingly, since the formation of the reference dots D at a position displaced from the position where the reference dot D should be formed with respect to the recording paper P is prevented in advance, the lowering of the recording accuracy caused thereby is prevented in advance.

What is claimed is:

1. A reference mark forming device configured to form reference marks on a recorded material to be transported in a predetermined transporting direction by a transporting device at a predetermined regular pitch in the transporting direction comprising:
a reference-mark-specific head configured to form the reference marks on the recorded material transported by the transporting device;
a mark detection sensor configured to detect the reference marks formed on the recorded material by the reference-mark-specific head on the downstream side of the reference-mark-specific head in terms of the transporting direction; and
a head drive unit configured to drive the reference-mark-specific head on the basis of an output signal from the mark detection sensor,
wherein the reference-mark-specific head and the mark detection sensor are arranged so that the relative positional relation is maintained constant, and
the head drive unit forms the subsequent reference mark on the basis of the position of the reference mark detected by the mark detection sensor.

2. The mark forming device according to claim 1, wherein the reference-mark-specific head includes a plurality of mark forming elements disposed at the predetermined regular pitch in the transporting direction, and
the head drive unit drives at least two mark forming elements from among the plurality of mark forming elements simultaneously to form two or more reference marks simultaneously.

3. A reference-mark-specific head module comprising the reference-mark-specific head and the mark detection sensor according to claim 1, wherein the reference-mark-specific head and the mark detection sensor are arranged so that the relative positional relation is maintained constant.

4. A recording apparatus comprising:
a transporting device configured to transport a recorded material in a predetermined transporting direction;
a recording head configured to form a dot on a recording surface of the recorded material transported by the transporting device;
a reference mark sensor arranged in the proximity of the recording head to detect the reference mark;
a control device configured to control the dot formation timing of the recording head on the basis of a reference mark detection signal outputted from the reference mark sensor; and
the reference mark forming device according to claim 1.

5. The recording apparatus according to claim 4, comprising:
an inclination detection sensor configured to detect inclination of the recorded material transported by the transporting device with respect to the transporting direction; and
an inclination angle adjusting device configured to adjust the inclination angle of the reference mark forming device with respect to the transporting direction,
wherein the control device controls the inclination angle adjusting device on the basis of an output signal from the inclination detection sensor.

6. The recording apparatus according to claims 4 comprising:
a position detection sensor configured to detect a position in the direction intersecting the transporting direction of the recorded material transported by the transporting device; and
a position adjusting device configured to displace the reference mark forming device in the direction intersecting the transporting direction,
wherein the control device controls the position adjusting device on the basis of an output signal from the position detection sensor.
